(19) United States
(12) Patent Application Publication
(10) Pub. No.: US 2015/0256309 A1
(43) Pub. Date: Sep. 10, 2015

(54) METHODS AND APPARATUSES FOR WIRELESSLY COMMUNICATING IN A MULTIPLE USER-MULTIPLE-IN-MULTIPLE-OUT NETWORK

(71) Applicant: Samsung Electronics Co., Ltd., Gyeonggi-do (KR)

(72) Inventors: Fei TONG, Bassingbourn (GB); Mark G. Rison, Cambridge (GB)

(73) Assignee: Samsung Electronics Co., Ltd.

(21) Appl. No.: 14/466,442

(22) Filed: Aug. 22, 2014

Related U.S. Application Data
(60) Provisional application No. 61/948,896, filed on Mar. 6, 2014.

(51) Int. Cl. H04L 5/00; H04B 7/04

(52) U.S. Cl. CPC H04L 5/0037; H04B 7/0452; H04L 5/0023

(57) ABSTRACT

A method for wirelessly communicating Physical Protocol Data Units (PPDUs) in a network is provided. The method includes assigning a group IDentifier (ID) in at least one first subfield of an existing field of a Multiple User-Multiple-In-Multiple-Out (MU-MIMO) PPDU supporting multiplexing over a spatial domain, the group ID indicating a group of Stations (STAs) of which each STA includes a set of PDUs in the MU-MIMO PPDU; differentiating the MU-MIMO PPDU as one of a Frequency Multiplexed (FM)-MU PPDU and a Spatial Multiplexed (SM)-MU PPDU; and defining at least one second subfield of the existing field of the MU-MIMO PPDU as user Bandwidth (BW) subfield indicating a number of sub-channels allocated for each STA in the group of STAs. The number of sub-channels allocated to each STA indicates a position in a multiplexing order for each STA in the group of STAs.

### PRIORITY

The present invention claims priority to U.S. Provisional Application Ser. No. 61/948,896, which was filed in the United States Patent and Trademark Office on Mar. 6, 2014, the entire disclosure of which is incorporated herein by reference.

### BACKGROUND OF THE INVENTION

1. Field of the Invention

The present invention relates to methods and apparatuses for wirelessly communicating in a multiple user (MU) network and, more particularly, to methods and apparatuses supporting either Spatial Multiplexed (SM)-MU or Frequency Multiplexed (FM)-MU Physical Protocol Data Units (PPDUs).

2. Description of the Related Art

MIMO communication networks, in the IEEE 802.11n standard, allow for the communication of one or more spatial data streams. Each PPDU in the MIMO communication network contains one or more PDUs for a single station (STA), e.g., in a unicast scenario, or for a group of STAs, e.g., in a multicast or a broadcast scenario.

MU-MIMO techniques, in the IEEE 802.11ac standard, exploit the availability of multiple independent transmitting radio STAs, e.g., Access Points (APs), in order to enhance the communication capabilities of APs. In a MU-MIMO PPDU, one PPDU can multiplex up to four sets of PDUs in the spatial domain, e.g., Spatial Multiplexed PPDU (SM PPDU), with each of the four sets of PDUs targeting a specific STA. Such a multiplexing process allows APs with limited or no MIMO capabilities to multiplex sets of PDUs to multiple STAs, which may not have MIMO capability.

However, known MIMO and/or MU-MIMO PPDUs may not provide such multiplexing capability over frequency, which would be useful in achieving superior spectrum efficiency within the MIMO and/or MU-MIMO communication networks. For example, when individual

STAs have short PDU traffic, e.g., due to control/management of the individual AP or a particular application of the AP, such frequency multiplexing capabilities would allow for multiplexing packets for different STAs. Such multiplexing capabilities would provide an efficient use of the available spectrum within the MIMO and/or MU-MIMO communication networks.

Therefore, there exists a need for methods and apparatuses that support FM-MU PPDUs in MIMO and/or MU-MIMO communication networks.

### SUMMARY OF THE INVENTION

The present invention has been made to address the above problems and disadvantages, and to provide at least the advantages described below. Accordingly, an aspect of the present invention is to provide methods and apparatuses that support FM-MU PPDUs in MIMO and/or MU-MIMO communication networks.

An aspect of the present invention is to provide a method for reusing an existing signalling method of a MIMO and/or MU-MIMO network that supports spatial multiplexing to achieve frequency multiplexing, with minor limitations on the multiplexing flexibility, for a single spatial stream PPDU.

Another aspect of the present invention is to provide a method for reusing the signalling field definition for MIMO and/or MU-MIMO PPDUs for multiplexing PDUs over the frequency domain (separate sets of PDUs allocated in different parts of a channel). More particularly, each set of signalling fields currently used to indicate the spatial stream indices per a particular receiving STA, e.g., a user STA, is instead used to indicate the number of 20 MHz sub-channels used to carry the set of PDUs targeting that particular STA.

Yet another aspect of the present invention is to provide a method for reusing MIMO and/or MU-MIMO signalling bits in the existing signalling fields to indicate frequency multiplexing allocation, thereby avoiding extra signalling overhead; this also results in a unified signalling structure for both spatial and frequency multiplexing and leads to simple extension in signalling field parsing logic.

According to an aspect of the present invention, a method for wirelessly communicating PPDUs in a network is provided. The method includes assigning a group Identifier (ID) to at least one first subfield of an existing field of a MU-MIMO PPDU supporting multiplexing over a spatial domain, the group ID indicating a group of STAs of which each STA includes a set of

PDUs in the MU-MIMO PPDU; differentiating the MU-MIMO PPDU as one of an FM-MU PPDU and an SM-MU PPDU; and defining at least one second subfield of the existing field of the MU-MIMO PPDU as a user Bandwidth (BW) subfield indicating a number of sub-channels allocated for each STA in the group of STAs, the number of sub-channels allocated to each STA indicating a position in a multiplexing order for each STA in the group of STAs.

According to another aspect of the present invention, a method for wirelessly communicating in a network is provided. The method includes transmitting a MU-MIMO PPDU supporting multiplexing over a frequency and a spatial domain to a group of STAs of which each STA includes a set of PDUs in the MU-MIMO PPDU; receiving at at least one STA in the group of STAs the MU-MIMO PPDU; determining if the received MU-MIMO PPDU is one of an FM-MU PPDU and an SM-MU PPDU; and decoding the received MU-MIMO PPDU based on the determination of whether the MU-MIMO PPDU is the FM-MU PPDU or the SM-MU PPDU.

According to another aspect of the present invention, an AP for wirelessly communicating in a network is provided. The AP includes a processor configured to assign an ID in at least one first subfield of an existing field of a MU-MIMO PPDU supporting multiplexing over a spatial domain, the group ID indicating a group of STAs of which each STA includes a set of PDUs in the MU-MIMO PPDU, to differentiate the MU-MIMO PPDU as one of an FM-MU PPDU and an SM-MU PPDU, and to define at least one second subfield of the existing field of the MU-MIMO PPDU as user Bandwidth (BW) subfield indicating a number of sub-channels allocated for each STA in the group of STAs, the number of sub-channels allocated to each STA indicating a position in a multiplexing order for each STA in the group of STAs.

According to another aspect of the present invention, a STA for wirelessly communicating in a network is provided. The STA includes a processor configured to receive a MU-MIMO PPDU supporting multiplexing over a frequency and a spatial domain to a group of STAs of which each STA includes a set of PDUs in the MU-MIMO PPDU, to determine if the received MU-MIMO PPDU is one of an FM-MU PPDU and an SM-MU PPDU, and to decode the received MU-MIMO PPDU based on the determination of whether the MU-MIMO PPDU is the FM-MU PPDU or the SM-MU PPDU.

According to another aspect of the present invention, a sniffer for wirelessly communicating in a network is provided. The sniffer includes a processor configured to detect MU-MIMO PPDUs supporting multiplexing over a spatial domain, the MU-MIMO PPDUs are differentiated as one of an FM-Multi-User PPDU and an SM-MU PPDU and are assigned a group ID in at least one first subfield of an existing field of the MU-MIMO PPDU, the group ID indicating a group of STAs of which each STA includes a set of PDUs in the MU-MIMO PPDU, and to decode the sets of PDUs of each STA in the group of STAs.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a diagram illustrating a MU-MIMO network, according to an embodiment of the present invention;

FIG. 2 is a diagram illustrating an FM-MU PPDU having an 80 MHz transmission BW, according to an embodiment of the present invention;

FIG. 3A is a block diagram illustrating components of an AP and an STA configured for use in the MU-MIMO network shown in FIG. 1, according to an embodiment of the present invention;

FIG. 3B a signal processing diagram illustrating a method for processing the FM-MU PPDU at the AP using Binary Convolution Coding (BCC) and Low Density Parity Check (LDPC), according to an embodiment of the present invention;

FIG. 4 is a flowchart illustrating a method for wirelessly communicating PPDUs in a MU-MIMO network, according to an embodiment of the present invention;

FIG. 5 is a flowchart illustrating a method for wirelessly communicating in a MU-MIMO network, according to an embodiment of the present invention; and

FIG. 6 is a diagram illustrating an FM-MU PPDU having a 160 MHz transmission BW, according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configurations and components are merely provided to assist in the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In view of the aforementioned shortcomings associated with known MIMO and MU-MIMO communication networks, methods and apparatuses supporting FM-MU PPDUs are described herein.

The embodiments of the present invention support multiplexing sets of PDUs for different STAs or groups of STAs in a frequency domain. The multiplexed sets of PDUs are carried in different parts of a channel used in a MIMO and MU-MIMO network.

Moreover, the embodiments of the present invention utilize one or more existing signalling fields of a MIMO and/or MU-MIMO PPDU, which support multiplexing over a spatial domain, to carry frequency allocation information to one or more STAs or groups of STAs.

The methods and apparatuses according to embodiments of the present invention can be implemented in either the MIMO or MU-MIMO communication networks. However, for illustrative purposes, such methods and apparatuses are described herein in terms of use with a MU-MIMO communication network.

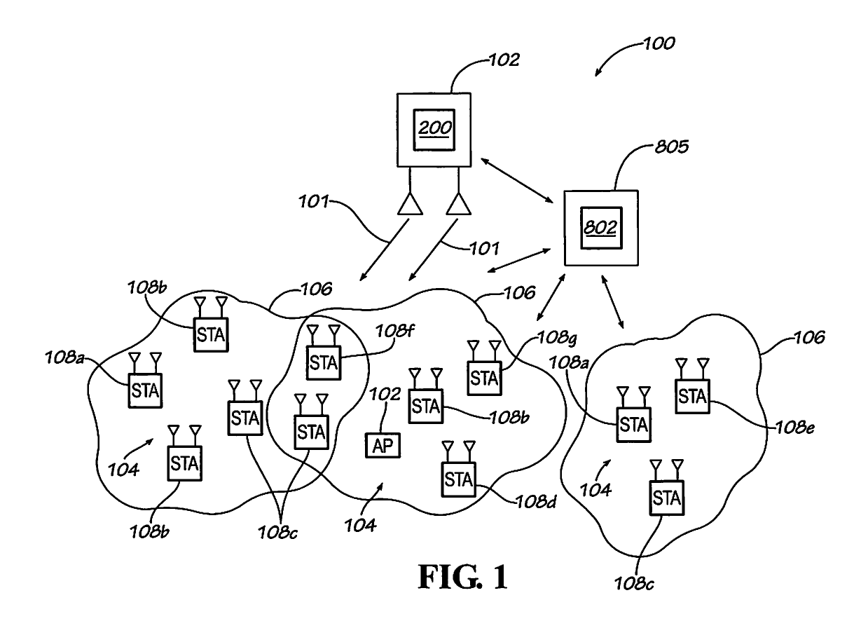

FIG. 1 illustrates a MU-MIMO network 100, according to an embodiment of the present invention. The MU-MIMO network 100 includes a MU-MIMO AP 102, e.g., a transmitting terminal, and a plurality of associated user STAs 104, e.g., receiving terminals. The individual user STAs 104 may be embodied in the form of cell phone 108a, Personal Digital Assistant (PDA) 108b, laptop 108c, workstation 108d, personal computer 108e, video camcorder 108f, and video projector 108g. Moreover, one or more of the STAs 104 can be embodied as another AP 102.

One or more sniffers 805 may be implemented in the MU-MIMO network 100, as will be described in more detail below.

While the AP 102 is described as the transmitting terminal and the STA 104 as the receiving terminal, it will be understood by those skilled in the art that both the AP 102 and STA 104 can each receive and transmit radio signals.

The AP 102 and at least some of the user STAs 104 may be configured for MU-MIMO communications in which the AP 102 may transmit MU-MIMO transmissions for reception by the MU-MIMO configured user STAs 104. In the illustrated embodiments of the present invention, the MU-MIMO network 100 is a

Very-High Throughput (VHT) Base Station Service set (BSS) configured to operate in accordance with one of the IEEE 802.11 standards such as the IEEE 802.11n and IEEE 802.11 ac standards. However, other IEEE 802.11 standards are contemplated.

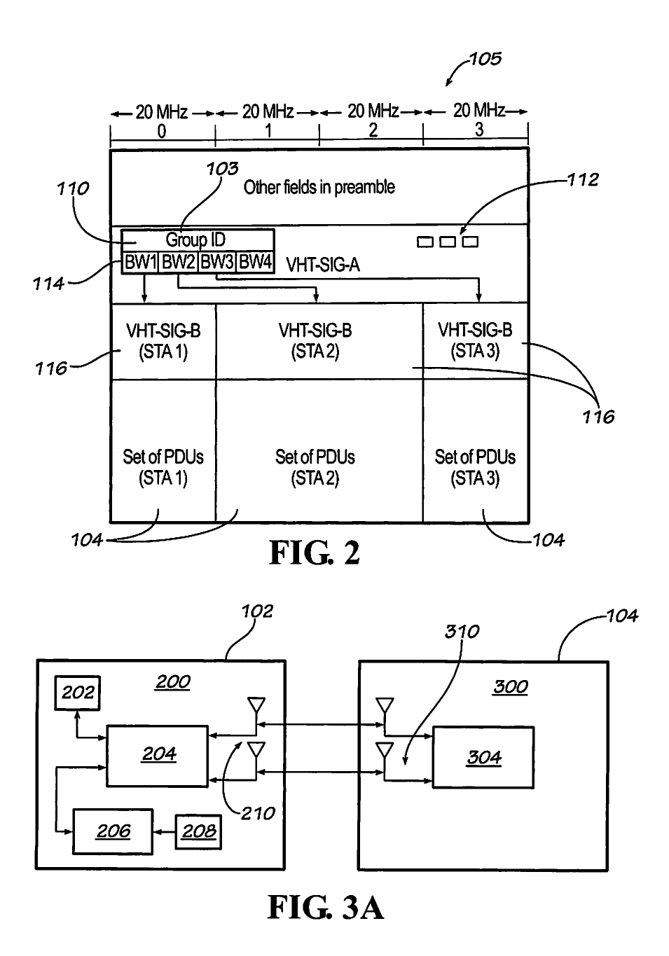

Continuing with reference to FIG. 1, the AP 102 may manage groups of two or more of the user STAs 104 for MU-MIMO communications in which the user STAs 104 are assigned to one or more groups of STAs 106 for receipt of a MU-MIMO transmission 101 that includes a MU-MIMO PPDU 105 (FIG. 2), which can be configured as either an SM-MU PPDU or an FM-MU PPDU, as described in more detail below.

The AP 102 assigns a group STA Identifier ID 103 (hereinafter simply referred to as ID 103) to the MU-MIMO PPDU 105 indicating each of a plurality of associated user STAs 104 in the group of STAs 106 (see FIG. 2 for example). The ID 103 also indicates the group of STAs 106 to be multiplexed in the MU-MIMO PPDU 105. Each ID 103 may be assigned to a different group of STAs 106 of two or more of the associated user STAs 104. The ID 103 may be integer values or other suitable values, e.g., a number of bits.

The AP 102 is configured to generate and transmit the MU-MIMO transmission 101, which includes one or more spatial streams (not shown). For example, when the MU-MIMO transmission 101 transmits a MU-MIMO PPDU 105 that is FM, the MU-MIMO transmission 101 includes one spatial stream that is transmitted over various frequencies to the intended STAs 104 in the group of STAs 106. Conversely, when the MU-MIMO transmission 101 transmits a MU-MIMO PPDU 105 that is SM, the MU-MIMO transmission 101 includes two or more spatial streams that are transmitted to the intended STAs 104 in the group of STAs 106.

FIG. 2 is a diagram illustrating an FM-MU PPDU having an 80 MHz transmission BW, according to an embodiment of the present invention. In accordance with the embodiments of the present invention, the AP 102 enables frequency multiplexing of sets of PDUs associated with a user STA 104 (illustrated in FIG. 2 as STA 1, STA 2, STA 3) in the MU-MIMO PPDU 105 by reusing the existing signalling fields allocated for use when the MU-MIMO PPDU 105 is to be SM.

The FM-MU PPDU shown in FIG. 2 is transmitted over an 80 MHz BW, and each STA 104 in the group of STAs 106 is equipped with 80 MHz of BW capability. For illustrative purposes, the FM-MU PPDU of FIG. 2 is shown including three user STAs 104, e.g., STAs 1-3, in the group 106. Specifically, two user STAs 104, e.g., STA 1 and 3, in the group of STAs 106 may, for example, be allocated a 20 MHz BW and one user STA 104, e.g., STA 2, may be allocated a 40 MHz BW. As can be appreciated, other user STA 104 BW allocations can be implemented as long as the combined total BW of each STA 104 in the group of STAs 106 does not exceed the 80 MHz bandwidth. For example, in embodiments of the present invention, two user STAs 104 can each be allocated a 40 MHz BW.

In the embodiments of the present invention, the AP 102 uses one or more methods to differentiate between frequency multiplexing and spatial multiplexing which allows the user STAs 104 in the groups of STAs 106 to determine an appropriate demodulation process for demodulating the received sets of PDUs in the MU-MIMO PPDU 105.

As noted above, the AP 102 assigns the ID 103 to the MU-MIMO PPDU 105 indicating the user STAs 104 in the group of STAs 106 and the group of STAs 106 to be multiplexed in the MU-MIMO PPDU 105. In accordance with the embodiments of the present invention, the ID 103 is assigned to one or more existing signalling fields in the MU-MIMO PPDU 105. In the embodiment illustrated in FIG. 2, for example, the ID 103 is assigned to a first subfield 110 in a

Very High Throughput-Signal-A (VHT-SIG-A) signalling field of the MU-MIMO PPDU 105.

In order for the user STAs 104 to determine whether the received MU-MIMO PPDU 105 is an SM-MU PPDU or FM-MU PPDU, one or more mechanisms can be implemented to differentiate between these two multiplexing techniques. For example, one or more bits or values associated with the fields and/or sub-fields of the MU-MIMO PPDU 105 can be used to indicate if the MU-MIMO PPDU 105 is an SM-MU PPDU or FM-MU PPDU. In an embodiment of the present invention, for example, one of three bits 112, which are currently unused in the VHT-SIG-A signalling field associated with conventional MU-MIMO PPDUs, can be set (or unset) to indicate if the MU-MIMO PPDU 105 is an FM-MU PPDU or SM-MU PPDU. In another embodiment of the present invention, values 5-7, which are currently reserved in a sub-field of the National Space Transportation System (NSTS) signalling field, can be set (or unset) or assigned to indicate if the MU-MIMO PPDU 105 is an SM-MU PPDU or FM-MU PPDU. For example, the values 5-7 can be used to indicate per user bandwidth (e.g., 20, 40 or 80 MHz), which, in turn, can be used to indicate (or imply) if the MU-MIMO PPDU is an FM-MU PPDU or SM-MU PPDU.

In another embodiment of the present invention, characteristics of the MU-MIMO transmission 101 can be used to indicate if the MU-MIMO PPDU 105 is an SM-MU PPDU or FM-MU PPDU. For example, user STAs 104 could identify whether the MU-MIMO PPDU 105 is an FM-MU PPDU or SM-MU PPDU by assessing a number of spatial streams or by assessing the number of spatial streams and the ID 103 used in the MU-MIMO PPDU 105. For example, when the number of spatial streams is 1 and the ID 103 indicates multiplexing (i.e., the group of STAs 106 is representative of a multiplexing process), this can be used to indicate that the MU-MIMO PPDU 105 is an FM-MU PPDU. That is, a MU-MIMO PPDU 105 that is FM can be transmitted across one spatial stream, whereas the MU-MIMO PPDU 105 that is SM is transmitted across two or more spatial streams.

In yet another embodiment, a parameter of Medium Access Control (MAC) used to encode each set of PDUs in the MU-MIMO PPDU 105 could be used to indicate if the MU-MIMO PPDU 105 is an FM-MU PPDU or an SM-MU PPDU. In this embodiment, a user STA 104 that receives the MIMO PPDU 105 can be configured to identify a parameter of the MAC to determine if the MU-MIMO PPDU 105 is an FM-MU PPDU or an SM-MU PPDU.

Continuing with reference to FIG. 2, if the MU-MIMO PPDU 105 is to be transmitted as an FM-MU PPDU, the AP 102 defines (or redefines) one or more second subfields 114 of the existing signalling fields of the MU-MIMO PPDU 105 as user BW. Specifically, an NSTS sub-field, which is defined in VHT-SIG-A signalling field for conventional MU-MIMO PPDUs, is redefined as the user BW signalling field in an FM-MU PPDU.

In FIG. 2 the user BW is illustrated in the second subfield 114 as BW1, BW2, BW3, BW4, which correspond to each of the user STAs 104 that may be in the group of STAs 106 in the MU-MIMO PPDU 105; this assumes that there are four user STAs 104 allocated at a maximum 20 MHz BW in an FM-MU PPDU that is transmitted across an 80 MHz BW. In this instance, each of BW1-BW4 will be assigned to a respective one of the user STAs 104 in the group of STAs 106. In FIG. 2, however, since there are only three user STAs 104 being used, each of the three user STAs 104 is assigned to their respective BW designation, i.e., a STA 1 is allocated to BW1, a STA 2 is allocated to BW 2, etc.

If the MU-MIMO PPDU 105 is to be transmitted as the FM-MU MIMO PPDU, the redefined second subfield 114 will contain information regarding a number of sub-channels allocated for each user STA 104 in the group of user STAs 106. The number of sub-channels allocated for each user STA 104 indicates a position in a multiplexing order for each user STA 104 in the group of STAs 106.

Accordingly, once each user STA 104 receives the transmitted MU-MIMO PPDU 105 and determines that the MU-MIMO PPDU 105 is an FM-MU PPDU, each user STA 104 in the group of STAs 106 can determine its position in the multiplexing order based on the number of sub-channels allocated to each of the user STAs 104. Specifically, each user STA 104 can determine a frequency and BW of its set of PDUs in the FM-MU PPDU by reading a number of 20 MHz sub-channels allocated to the other user STAs 104, combined with the number of 20 MHz sub-channels allocated to that particular user STA 104.

If the MU-MIMO PPDU 105 is to be transmitted as the FM-MU PPDU, VHT-SIG-B fields 116 of the FM-MU PPDU will include or indicate a MAC that is used to encode each set of PDUs associated with each of the user STAs 104 in the FM-MU PPDU. Accordingly, once a user STA 104 knows its BW, that particular user STA 104 can proceed with decoding the VHT-SIG-B field, which occupies the same BW as the set of PDUs for that particular user STA 104, using the MAC included or indicated for that particular STA 104.

In accordance with embodiments of the present invention, the group of STAs 106 which sets of PDUs that may be multiplexed in a frame is semi-static, i.e., the group of STAs 106 remains unchanged for a relatively long period, e.g., seconds, but may change over a longer term.

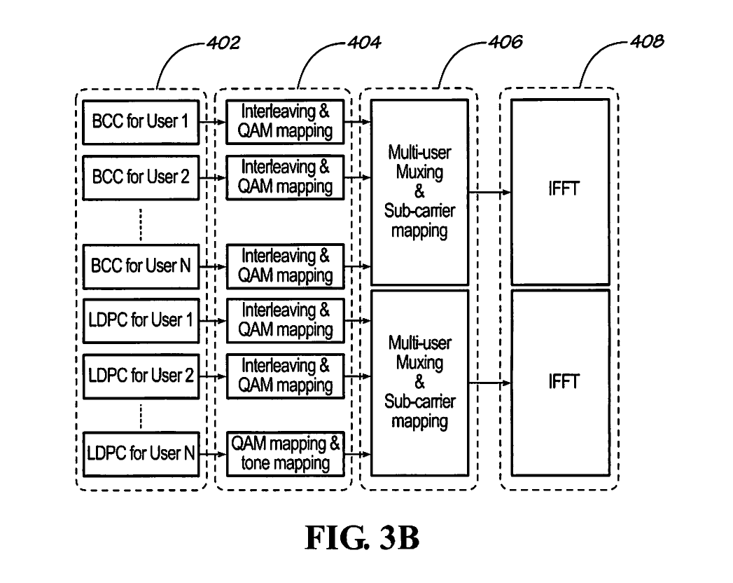

FIG. 3A is a block diagram illustrating pertinent components of the AP 102 and the STAs 104.

The AP 102 includes a processor 200, a combination BCC/LDPC module 202, one or more modulators/demodulators 204, one or more multiplexers 206, one or more Inverse Fast Fourier Transformation (IFFT) modules 208, and one or more antennas 210 (two antennas 210 are shown in FIG. 3A). The AP 102 may also include a controller, a scheduler, data source, etc. (not shown).

On the downlink, the processor 200 of the AP 102 receives traffic data for one or more of the user STAs 104 at the antennas 210. The processor 200 also processes, e.g., encodes, interleaves, and symbol maps, the different types of data based on one or more coding and modulation schemes, e.g., FM-MU PPDU or SM-MU PPDU, to obtain streams of data symbols.

The modulator/demodulator 204, e.g., a modulator that performs Quadrature Amplitude Modulation (QAM), receives and processes a respective transmit symbol stream from the antennas 210 to obtain a stream of symbols, and further conditions, e.g., amplifies, filters, and frequency upconverts, the symbol stream to generate and transmit a downlink signal to the user

STAs 104 in the group of STAs 106.

The components of the AP 102 allow the AP 102 to wirelessly communicate in the MU-MIMO network 100. Specifically, the processor 202 assigns the ID 103 in the first subfield 110 of the existing field of the MU-MIMO PPDU 105, which supports multiplexing over a spatial domain.

As noted above, the group ID 103 indicates a group of the STAs 106 of which each user STA 104 includes a set of PDUs in the MU-MIMO PPDU 105. The MU-MIMO PPDU 105 is differentiated as one of an FM-MU PPDU and an SM-MU PPDU. The second subfield 114 of the existing field of the MU-MIMO PPDU 105 is defined as the user BW subfield which indicates a number of sub-channels allocated for each user STA 104 in the group of STAs 106. As noted above, the number of sub-channels allocated to each STA 106 indicates a position in a multiplexing order for each user STA 104 in the group of STAs 106.

Referring again to FIG. 3A, the STAs 104 may include components similar to the AP 102. For illustrative purposes, however, the STAs 104 are shown only including a processor 300, a modulator/demodulator 304, and two antennas 310. The STAs 104 may also include a controller, a scheduler, data source, a BCC module, multiplexers, one or more IFFT modules, etc. (not shown).

On the downlink, the antennas 310 receive the downlink signals, and each antenna 310 provides a received signal to the processor 300. Upon receipt of the received MU-MIMO PPDU 105, the processor 300 determines if MU-MIMO PPDU 105 is an FM-MU PPDU or an SM-MIMO PPDU.

Thereafter, the demodulator 304 performs processing complementary to that performed by modulator 204 of the AP 102 and provides a stream of received data symbols. The recovered data symbols can then be processed, e.g., demapped, deinterleaved, and decoded, to obtain decoded data for each transport channel (not shown), which may be provided to data storage device (not shown) for storage and/or back to the processor 300 for further processing.

The components of the user STAs 104 allow the user STAs 104 to wirelessly communicate in the MU-MIMO network 100. Specifically, the processor 300 is configured to receive the MU-MIMO PPDU 105 which supports multiplexing over a frequency and a spatial domain to the group of STAs 106 of which each user STA 104 includes a set of PDUs in the MU-MIMO PPDU 105. The processor 300 then determines if the received MU-MIMO PPDU 105 is an FM-MU PPDU or an SM-MU PPDU. Thereafter, the processor 300 decodes the received MU-MIMO PPDU 105 based on the determination of whether the MU-MIMO PPDU 105 is the FM-MU PPDU or the SM-MU PPDU.

FIG. 3B is a signal processing diagram illustrating a method of processing the FM-MU PPDU using BCC and LDPC, according to an embodiment of the present invention. As can be appreciated, such a method can also be implemented for processing the SM-MIMO PPDU.

Prior to transmitting an FM-MU PPDU from the AP 102, the BCC/LDPC module 202 performs a BCC and/or LDPC operation on the sets of PDUs associated with each user station 104, at block 402. For illustrative purposes, the processing method of FIG. 3B is described in terms of a single user STA 104 in the group of STAs 106. At block 402, multiple independent Forward Error Check (FEC) coding may also be performed on the sets of PDUs associated with each user STA 104 by the BCC/LDPC module 202.

In the embodiment illustrated in FIG. 3B, the modulator/demodulator 204 performs QAM and interleaving on the sets of PDUs associated with each user station 104 in the group of STAs 106, at block 404.

The PDUs associated with each user STA 104 are then FM using the multiplexer 206. Specifically, the QA modulated symbols are allocated to different subcarrier blocks, e.g., via subcarrier mapping, according to a position in a multiplexing order for each user STA 104 in the group of STAs 106 and the frequency and BW allocation, at block 406. After the mapping and multiplexing process, an IFFT process is performed on the FM PDUs associated with each user station 104 by the IFFT module 208, at block 408.

Thereafter, the FM-MU PPDU may be transmitted from the IFFT module 208 (or other module of the AP 102) to one or both of the antennas 210 from where it is transmitted on the spatial stream of the MU-MIMO transmission 101 to the user STAs 104, e.g., STA 1, STA 2, STA 3, in the group of STAs 106 according to the ID 103 indicated on the FM-MU PPDU.

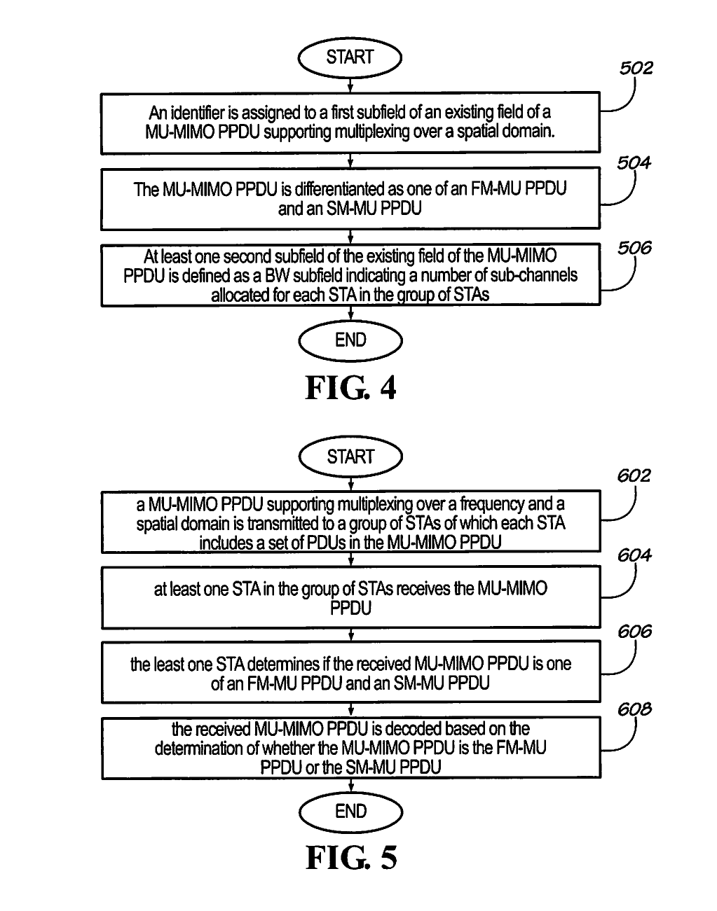

FIG. 4 illustrates a flowchart for wirelessly communicating PPDUs in the MU-MIMO network 100. At step 502, the ID 103 is assigned to the first subfield 110 of the existing field, e.g., the VHT-SIG-A field of a MU-MIMO PPDU 105, which supports multiplexing over the spatial domain. The ID 103 indicates the group of STAs 106 of which each user STA 104 includes a set of PDUs in the MU-MIMO PPDU 105.

At step 504, the MU-MIMO PPDU 105 is differentiated as one of an FM-MU PPDU and a SM-MU PPDU.

At step 506, the subfield 114 of the VHT-SIG-A field of the MU-MIMO PPDU 105 is defined as the BW subfield 114 indicating the number of sub-channels allocated for each user STA 104 in the group of STAs 106. The number of sub-channels allocated to each user STA 104 indicates a position in a multiplexing order for each user STA 104 in the group of STAs 106.

FIG. 5 illustrates a method for wirelessly communicating in the MU-MIMO network 100.

At step 602, the MU-MIMO PPDU 105, which supports multiplexing over a frequency and a spatial domain, is transmitted to the group of STAs 106 of which each user STA 104 includes a set of PDUs in the MU-MIMO PPDU 105.

At step 604 at least one user STA 104 in the group of STAs 106 receives the MU-MIMO PPDU 105. Thereafter, at step 606, the least one user STA 104 determines if the received MU-MIMO PPDU 105 is one of the FM-MU PPDU and the SM-MU PPDU.

At step 608, the received MU-MIMO PPDU 105 is decoded based on the determination of whether the MU-MIMO PPDU 105 is an FM-MU PPDU or an SM-MU PPDU.

While embodiments of the present invention have been described herein in terms of MU-MIMO signalling fields for supporting up to four STAs 104, other embodiments are contemplated.

For example, in embodiments of the present invention the 80 MHz BW can be extended to other BW schemes such as, for example, 160 MHz BW (or 80+80 MHz BW). In such an embodiment, each user STA 104 in the group of STAs 106 can be allocated 40 MHz of BW. In this particular embodiment, to allow multiplexing to the user STAs 104 that have only 80 MHz receiver capability, the per-user allocation for each of the user STAs 104 that have 40 MHz of

BW may be restricted to be in the primary 80 MHz segment.

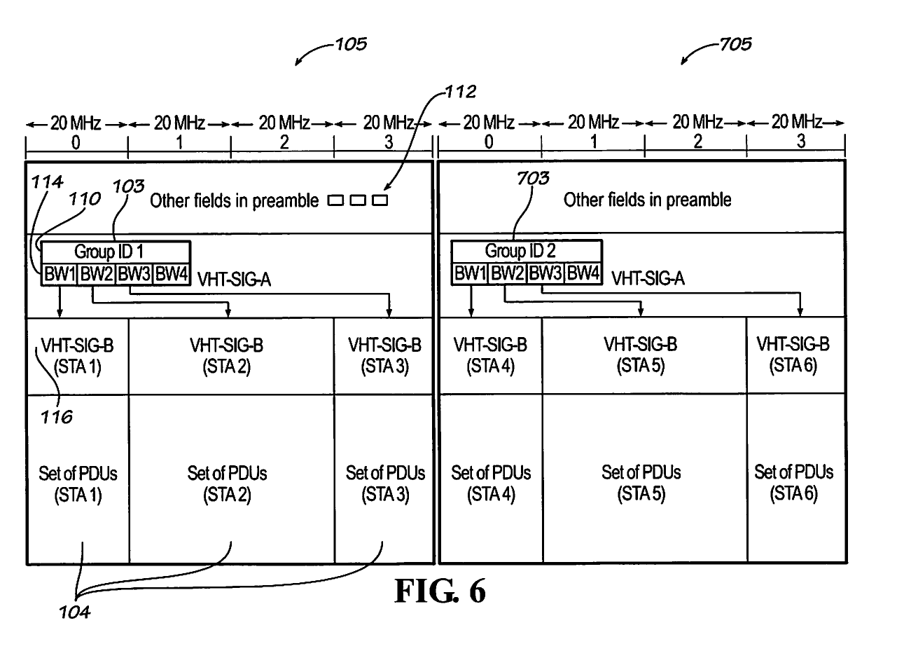

Alternatively, in another embodiment of the present invention, different groups of STAs 106 for each of the MU-MIMO PPDU 105 and an MU-MIMO 705 in a 160 MHz BW (or 80+80 MHz BW) may be used, as described below with regards to FIG. 6.

For example, as shown in FIG. 6, a user STA 104 with 160 MHz BW capability (or 80+80 MHz BW capability) may be configured to decode the MU-MIMO PPDU 105 or the MU-MIMO PPDU 705 associated with the group of STAs 106 that the user STA 104 belongs to and ignore the other MU-MIMO PPDU. For example, with an 80 MHz BW capable user STA 104, this user STA 104 can be configured to detect only the primary MU-MIMO PPDU, e.g., MU-MIMO PPDU 105.

The user STA 104 can determine if it should decode the MU-MIMO PPDU 105 or the MU-MIMO PPDU 705 based on the ID 103. For example, if the STA 104 is associated with the group of STAs 106 associated with ID 103, this STA 104 will decode the MU-MIMO PPDU 105 and ignore the MU-MIMO PPDU 705.

Other than the different BW allocations of STAs 104 in MU-MIMO PPDU 705 and an ID 703 designation assigned to the groups of STAs 106 in the MU-MIMO PPDU 705, the MU-MIMO PPDU 705 functions identically to the MU-MIMO PPDU 105. Therefore, a detailed description of the MU-MIMO PPDU 705 is not herein described.

In accordance with the foregoing, the embodiments of the present invention enable frequency multiplexing of multiple sets of PDUs in MU-MIMO PPDUs configured for spatial multiplexing by reusing the existing signalling field design for MU-MIMO PPDUs. Accordingly, the methods and apparatuses according to the present invention can generate FM-MU PPDUs with minimal changes to the existing signalling fields of the MU-MIMO PPDUs, which, in turn, provides the benefits of frequency multiplexing without any extra overhead.

Moreover, with an optimal loading scheme, sets of PDUs can be selectively put in the correct portion of a channel (e.g., up-fading portion of the channel) for each user STA 104. With such a loading scheme, combined with the above mentioned multiplexing capabilities, user diversity and optimal loading over frequency channel selectivity can be achieved.

As noted above, the MU-MIMO network 100 may also include a sniffer 805 (FIG. 1). The sniffer 805, or packet analyzer, can be used in the MU-MIMO network 100 to intercept and log traffic passing over the MU-MIMO network 100. The sniffer 805 may be implemented in hardware or software. As data streams flow across the MU-MIMO network 100, the sniffer 805 can be configured to capture MU-MIMO PPDUs and, if needed, decode and analyze their content or provide the captured MU-MIMO PPDUs to an analyzing tool for further processing. The captured MU-MIMO PPDUs may, for instance, be analyzed to obtain information about the network or the communication, e.g. to debug the communication or to diagnose problems of the MU-MIMO network 100.

Accordingly, in accordance with another embodiment of the present invention, the sniffer 805 is configured for wirelessly communicating in the MU-MIMO network 100. In this embodiment, the sniffer 805 includes a processor 802 that is configured to detect the MU-MIMO PPDU 105 which supports multiplexing over a spatial domain. As noted above, the MU-MIMO PPDU 105 can be differentiated as one of an FM-MU PPDU and an SM-MU PPDU and assigned an ID in the first subfield 110 of the existing field of the MU-MIMO PPDU 105. The ID 103 indicates a group of STAs 106 of which each STA 104 includes a set of PDUs in the MU-MIMO PPDU 105. In this embodiment, the processor 802 of the sniffer 805 is also configured to decode the sets of PDUs of each STA in the group of STAs.

While the present invention has been particularly shown and described with reference to certain embodiments thereof, it will be understood by those of ordinary skill in the art that various changes in form and details may be made therein without departing from the spirit and scope of the present invention.

What is claimed is:

1. A method for wirelessly communicating Physical Protocol Data Units (PPDUs) in a network, the method comprising:
assigning a group IDentifier (ID) to at least one first subfield of an existing field of a Multiple User-Multiple-In-Multiple-Out (MU-MIMO) PPDU supporting multiplexing over a spatial domain, the group ID indicating a group of Stations (STAs) of which each STA includes a set of PDUs in the MU-MIMO PPDU;
differentiating the MU-MIMO PPDU as one of a Frequency Multiplexed (FM)-MU PPDU and a Spatial Multiplexed (SM)-MU PPDU; and
defining at least one second subfield of the existing field of the MU-MIMO PPDU as a user Bandwidth (BW) subfield indicating a number of sub-channels allocated for each STA in the group of STAs, the number of sub-channels allocated to each STA indicating a position in a multiplexing order for each STA in the group of STAs.

2. The method of claim 1, wherein a minimum bandwidth allocated to each STA in the group of STAs ranges from about 20 MHz to about 80 MHz.

3. The method of claim 1, wherein the existing field of the MU-MIMO PPDU is a Very High Throughput-Signal-A (VHT-SIG-A) field.

4. The method of claim 1, wherein differentiating the PPDU as one of the FM-MU PPDU and the SM-MU PPDU includes setting at least one bit in the existing field of the MU-MIMO PPDU, assigning at least one value from the at least one second subfield of the MU-MIMO PPDU, using a number of spatial streams used in the MU-MIMO PPDU and the group ID, and using a parameter of a Medium Access Control (MAC) used to encode each set of the PDUs associated with each STA in the group of STAs in the MU-MIMO PPDU.

5. The method of claim 1, further comprising, if the MU-MIMO PPDU is an FM-MU PPDU, indicating in VHT-SIG-B fields of the FM-MU PPDU a MAC used to encode each set of the PDUs associated with each STA in the group of STAs.

6. The method of claim 1, further comprising, if the MU-MIMO PPDU is an FM-MU PPDU, performing for each set of the PDUs associated with each STA in the MU-MIMO PPDU:
Binary Convolution Coding (BCC);
Forward Error Coding (FEC); and
Quadrature Amplitude Modulation (QAM) and interleaving.

7. The method of claim 6, further comprising allocating subcarrier blocks for QAM modulated symbols of each set of the PDUs associated with each STA in the MU-MIMO PPDU based on a frequency allocation and the position in the multiplexing order for each STA in the group of STAs, and multiplexing each set of the PDUs associated with each STA in the MU-MIMO PPDU.

8. The method of claim 7, further comprising performing Inverse Fast Fourier Transformation on each set of the multiplexed PDUs.

9. The method of claim 1, further comprising, if the MU-MIMO PPDU is an FM-MU PPDU, performing for each set of the PDUs associated with each STA in the MU-MIMO PPDU:
Low Density Parity Check (LDPC);
Forward Error Coding (FEC); and
Quadrature Amplitude Modulation (QAM) and interleaving.

10. The method of claim 9, further comprising allocating subcarrier blocks for QAM modulated symbols of each set of the PDUs associated with each STA in the MU-MIMO PPDU based on a frequency allocation and the position in the multiplexing order for each STA in the group of STAs, and multiplexing each set of the PDUs associated with each STA in the MU-MIMO PPDU.

11. The method of claim 10, further comprising performing Inverse Fast Fourier Transformation on each set of the multiplexed PDUs.

12. A method for wirelessly communicating in a network, the method comprising:
transmitting a Multiple User-Multiple-In-Multiple-Out (MU-MIMO) Physical Protocol Data Unit (PPDU) supporting multiplexing over a frequency and a spatial domain to a group of Stations (STAs) of which each STA includes a set of PDUs in the MU-MIMO PPDU;
receiving at at least one STA in the group of STAs the MU-MIMO PPDU;
determining if the received MU-MIMO PPDU is one of a Frequency Multiplexed (FM)-MU PPDU and a Spatial Multiplexed (SM)-MU PPDU; and
decoding the received MU-MIMO PPDU based on the determination of whether the MU-MIMO PPDU is the FM-MU PPDU or the SM-MU PPDU.

13. The method of claim 12, wherein transmitting the MU-MIMO PPDU comprises, if the MU-MIMO PPDU is an FM-MU PPDU, assigning a group IDentifier (ID) to at least one first subfield of an existing field of the MU-MIMO PPDU.

14. The method of claim 13, wherein transmitting the MU-MIMO PPDU further comprises, if the MU-MIMO PPDU is an FM-MU PPDU, defining at least one second subfield of an existing field of the MU-MIMO PPDU as a user Bandwidth (BW) subfield indicating a number of sub-channels allocated for each STA in the group of STAs, the number of sub-channels allocated to each STA indicating a position in a multiplexing order for each STA in the group of STAs.

15. The method of claim 14, wherein, if the MU-MIMO PPDU is an FM-MU PPDU, each STA in the group of STAs determines a frequency and bandwidth of its set of PDUs based on the number of sub-channels allocated to that STA and a number of sub-channels allocated to other STAs in the group of STAs.

16. The method of claim 12, wherein, if the MU-MIMO PPDU is an FM-MU PPDU, a minimum bandwidth allocated to each STA in the group of STAs ranges from about 20 MHz to about 80 MHz.

17. The method of claim 13, wherein, if the MU-MIMO PPDU is an FM-MU PPDU, the existing field of the MU-MIMO PPDU is a Very High Throughput-Signal-A (VHT-SIG-A) field.

18. The method of claim 14, wherein determining if the received MU-MIMO PPDU is one of the FM-MU PPDU and the SM-MU PPDU includes detecting at least one bit set in the existing field of the MU-MIMO PPDU, detecting at least one value assigned in the at least one second subfield of the MU-MIMO PPDU, detecting a number of spatial streams used in the PPDU and the group ID, and identifying a parameter of a Medium Access Control (MAC) used to encode each set of PDUs in the PPDU.

19. The method of claim 12, wherein transmitting the MU-MIMO PPDU comprises, if the MU-MIMO PPDU is an FM-MU PPDU, indicating in VHT-SIG-B fields of the FM-MU PPDU a MAC used to encode each set of PDUs.

20. The method of claim 19, wherein decoding the received MU-MIMO PPDU comprises, if the MU-MIMO PPDU is an FM-MU PPDU, using the MAC to decode each set of PDUs in the MU-MIMO PPDU.

21. The method of claim 12, wherein transmitting the MU-MIMO PPDU further comprises, if the MU-MIMO PPDU is an the FM-MU PPDU, performing for each set of the PDUs associated with each STA in the MU-MIMO PPDU:
Binary Convolution Coding (BCC);
Forward Error Coding (FEC); and
Quadrature Amplitude Modulation (QAM) and interleaving.

22. The method of claim 21, further comprising allocating subcarrier blocks for QAM modulated symbols of each set of the PDUs associated with each STA in MU-MIMO PPDU based on a frequency allocation and the position in the multiplexing order for each STA in the group of STAs, and multiplexing each set of the PDUs associated with each STA in the MU-MIMO PPDU.

23. The method of claim 22, including performing Inverse Fast Fourier Transformation on each set of the multiplexed PDUs.

24. The method of claim 12, wherein transmitting the MU-MIMO PPDU further comprises, if the MU-MIMO PPDU is an FM-MU PPDU, performing for each set of the PDUs associated with each STA in the MU-MIMO PPDU:
Low Density Parity Check (LDPC);
Forward Error Coding (FEC); and
Quadrature Amplitude Modulation (QAM) and interleaving.

25. The method of claim 24, further comprising allocating subcarrier blocks for QAM modulated symbols of each set of the PDUs associated with each STA in MU-MIMO PPDU based on a frequency allocation and the position in a multiplexing order for each STA in the group of STAs, and multiplexing each set of the PDUs associated with each STA in the MU-MIMO PPDU.

26. The method of claim 25, including performing Inverse Fast Fourier Transformation on each set of the multiplexed PDUs.

27. An Access Point (AP) for wirelessly communicating in a network, the AP comprising:
a processor configured to assign a group IDentifier (ID) in at least one first subfield of an existing field of a Multiple User-Multiple-In-Multiple-Out (MU-MIMO) Physical Protocol Data Unit (PPDU) supporting multiplexing over a spatial domain, the group ID indicating a group of Stations (STAs) of which each STA includes a set of PDUs in the MU-MIMO PPDU, to differentiate the MU-MIMO PPDU as one of a Frequency Multiplexed (FM)-MU PPDU and a Spatial Multiplexed (SM)-MU PPDU, and to define at least one second subfield of the existing field of the MU-MIMO PPDU as user Bandwidth (BW) subfield indicating a number of sub-channels allocated for each STA in the group of STAs, the number of sub-channels allocated to each STA indicating a position in a multiplexing order for each STA in the group of STAs.

28. A user Station (STA) for wirelessly communicating in network, the STA comprising:
a processor configured to receive a Multiple User-Multiple-In-Multiple-Out (MU-MIMO) Physical Protocol Data Unit (PPDU) supporting multiplexing over a frequency and a spatial domain to a group of Stations (STAs) of which each STA includes a set of PDUs in the MU-MIMO PPDU, to determine if the received MU-MIMO PPDU is one of an Frequency Multiplexed (FM)-MU PPDU and an Spatial Multiplexed (SM)-MU PPDU, and to decode the received MU-MIMO PPDU based on the determination of whether the MU-MIMO PPDU is the FM-MU PPDU or the SM-MU PPDU.

29. A sniffer for wirelessly communicating in a network, the sniffer comprising:
a processor configured to detect Multiple User-Multiple-In-Multiple-Out (MU-MIMO) Physical Protocol Data Units (PPDUs) supporting multiplexing over a spatial domain, wherein the MU-MIMO PPDUs are differentiated as one of a Frequency Multiplexed (FM)-MU PPDU and a Spatial Multiplexed (SM)-MU PPDU and are assigned a group Identifier (ID) in at least one first subfield of an existing field of the MU-MIMO PPDU, the group ID indicating a group of Stations (STAs) of which each STA includes a set of PDUs in the MU-MIMO PPDU, and to decode the sets of PDUs of each STA in the group of STAs.
